(19) United States
(12) Patent Application Publication
(10) Pub. No.: US 2010/0057438 A1
(43) Pub. Date: Mar. 4, 2010

(54) PHRASE-BASED STATISTICS MACHINE TRANSLATION METHOD AND SYSTEM

(76) Inventors: Liu Zhanyi, Beijing (CN); Wang Haifeng, Beijing (CN)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/550,850

(22) Filed: Aug. 31, 2009

(30) Foreign Application Priority Data
Sep. 1, 2008 (CN) 200810214667.6

(51) Int. Cl. G06F 17/28

(52) U.S. Cl. 704/4

(57) ABSTRACT

A phrase-based statistics machine translation method includes for phrases in an input sentence, performing fuzzy matching in a pre-constructed phrase table. In the method, by performing fuzzy matching on the phrases, high quality translations can be generated for long phrases in the input sentence, thus the quality of the translation can be effectively increased with respect to the machine translation systems based on phrase exactly matching.

### CROSS-REFERENCE TO RELATED APPLICATIONS

This application is based upon and claims the benefit of priority from prior Chinese Patent Application No. 200810214667.6, filed Sep. 1, 2008, the entire contents of which are incorporated herein by reference.

### BACKGROUND OF THE INVENTION

1. Field of the Invention

The present invention relates to information processing technology, and particularly to a phrase-based statistics machine translation method and system.

2. Description of the Related Art

Machine translation technologies are mainly categorized as rule-based machine translation technologies and corpus-based machine translation technologies.

In the corpus-based machine translation technologies, the main translation resources come from a corpus repository. The corpus-based machine translation technologies are further categorized as example-based machine translation technologies and statistics-based machine translation technologies. In the statistics-based machine translation technologies, the phrase-based statistics machine translation (SMT) method is one of the main automatic machine translation methods.

The basic translation unit of the phrase-based statistics machine translation method is phrase, and the translation knowledge used therein consists of phrase table and language model obtained from parallel bilingual corpora in a corpus repository. The phrase table consists of bilingual phrase pairs in the parallel bilingual corpora. Herein, the phrase is defined as several continuous words.

The process of conventional phrase-based statistics machine translation mainly comprises the following steps: first, a phrase table is searched by using exactly matching method, so as to find all completely matched bilingual phrase pairs corresponding to an input sentence; then, based on the bilingual phrase pairs and a language model, all possible combinations of translation fragments in a target language are found for the input sentence, and the one having the highest score is selected from the all possible combinations by using a statistics method, as the correct target language translation of the input sentence.

FIG. 1 shows a block diagram of a conventional phrase-based statistics machine translation system implementing the above process. As shown in FIG. 1, the system 10 mainly comprises input unit 11, searching unit 12, translation generating unit 13, output unit 14, phrase table storing unit 15 and language model storing unit 16, etc.

The input unit 11 is an interface of the system 10 with the outside, and the system 10 obtains an input sentence to be translated from the outside through the input unit 11.

The searching unit 12 performs phrase exactly matching. Specifically, it searches a phrase table stored in the phrase table storing unit 15 for all completely matched bilingual phrase pairs corresponding to the input sentence by using exactly matching method.

Further, the translation generating unit 13 generates the correct target language translation of the input sentence. Specifically, it finds all possible translations in a target language for the input sentence based on the bilingual phrase pairs searched by the searching unit 12 and a language model stored in the language model storing unit 16, and selects the one having the highest score from the all possible translations by using a statistics model as the correct target language translation of the input sentence.

The target language translation generated by the translation generating unit 13 is output through the output unit 14.

FIG. 2 shows a machine translation example performed by the system of FIG. 1. In the example, for a Chinese input sentence [symbol] [symbol] (This means “I found the end of her story very exciting” in English.), the system of FIG. 1 finds in the phrase table the following four completely matched bilingual phrase pairs, Chinese-English phrase pairs, corresponding to the input sentence by using phrase exactly matching technique: (P1) [symbol] <->I found, (P2) [symbol] <->her, (P3) [symbol] <->the end of the story, and (P4) [symbol] <->very exciting. Moreover, based on the four bilingual phrase pairs, the system obtains the final translation “I found her the end of the story very exciting” by using the statistics model.

It can be seen from the above that in the conventional phrase-based statistics machine translation system, with respect to an input sentence to be translated, the exactly matching method is used to search a phrase table for completely matched bilingual phrase pairs to obtain the translation of the input sentence. The condition of the exactly matching method is that two matched phrases must be completely identical.

However, the size of the parallel bilingual corpus in a pre-constructed corpus repository is limited generally, and may not cover long phrases. Thus for long phrases in the input sentence to be translated, it is very difficult to find out completely matched bilingual phrase pairs in the phrase table by using the exactly matching method. Therefore, in the translation process, a long phrase can only be split into several short phrases for matching one by one.

However, because a long phrase contains more context information than a short phrase, the quality of the translation in the target language for an input sentence generated based on the matching of short phrases is usually lower than that generated based on the matching of long phrases.

### BRIEF SUMMARY OF THE INVENTION

According to one aspect of the present invention, there is provided a phrase-based statistics machine translation method, comprising: for phrases in an input sentence, performing fuzzy matching in a pre-constructed phrase table.

According to another aspect of the present invention, there is provided a phrase-based statistics machine translation system, comprising a phrase fuzzy matching unit configured to, for phrases in an input sentence, performing fuzzy matching in a pre-constructed phrase table.

### BRIEF DESCRIPTION OF THE SEVERAL VIEWS OF THE DRAWING

FIG. 1 is a block diagram of a conventional phrase-based statistics machine translation system;

FIG. 2 shows a machine translation example of the system of FIG. 1;

FIG. 3 is a flow chart of a phrase-based statistics machine translation method according to an embodiment of the present invention;

FIG. 4 is a detailed flow chart of a phrase fuzzy matching process in the method of FIG. 3 according to an embodiment of the present invention;

FIG. 5 shows a machine translation example using the method of FIGS. 3 and 4;

FIG. 6 is a block diagram of a phrase-based statistics machine translation system according to an embodiment of the present invention; and

FIG. 7 is a block diagram of a phrase fuzzy matching unit in the system of FIG. 6 according to an embodiment of the present invention.

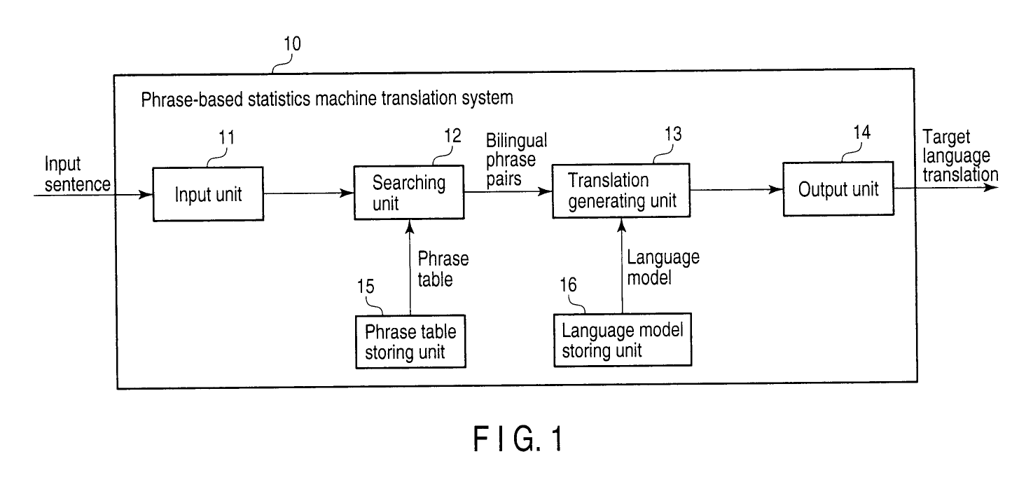

### DETAILED DESCRIPTION OF THE INVENTION

Next, a detailed description of each embodiment of the present invention will be given with reference to the drawings.

FIG. 3 is a flow chart of a phrase-based statistics machine translation method according to an embodiment of the present invention.

As shown in FIG. 3, first at step 305, an input sentence to be translated is obtained.

At step 310, phrase fuzzy matching is performed.

Specifically, at the step, a pre-constructed phrase table is searched for identical or the most similar bilingual phrase pair for each phrase in the input sentence by using a phrase fuzzy matching method, and the most similar bilingual phrase pair is modified, thus obtaining the correct translation of each phrase.

At step 315, a target language translation of the input sentence is generated.

Specifically, all possible translations in the target language for the input sentence are found based on the bilingual phrase pairs obtained at step 310 and a pre-constructed language model, and the one having the highest score is selected therefrom by using a statistics model, as the correct target language translation of the input sentence.

At step 320, the generated target language translation is output.

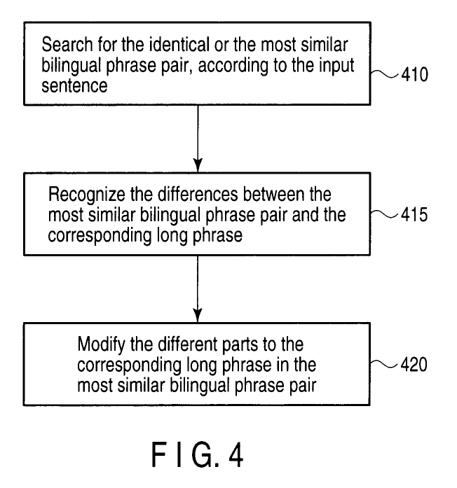

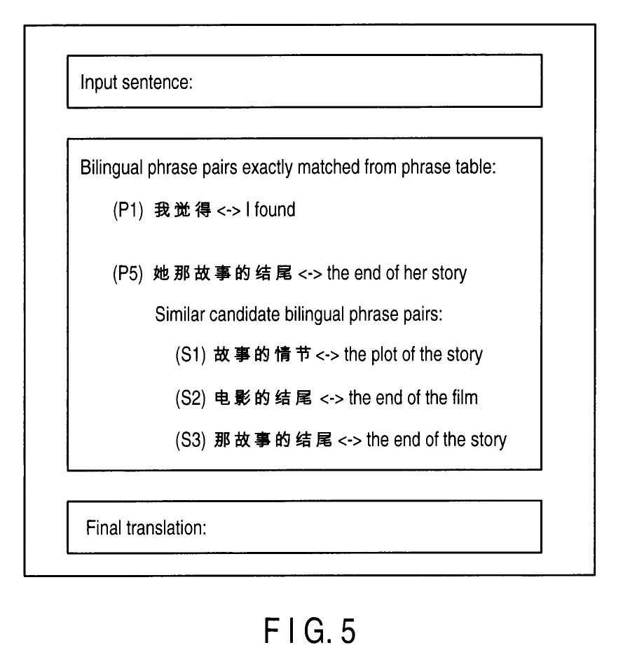

The process of the above step 310 will be described in detail below. FIG. 4 is a detailed flow chart of a phrase fuzzy matching process of the step 310 in the method of FIG. 3 according to an embodiment of the present invention. FIG. 5 shows a machine translation example using the method of FIGS. 3 and 4.

In the present embodiment, the process of phrase fuzzy matching is implemented according to the concept of Example-Based Machine Translation (EBMT). The main process of the EBMT method is as follows: first, an example sentence repository is searched for the example sentence similar to the input sentence; then, differences between the similar example sentence and the input sentence are recognized; and finally, the differences in the similar example sentence are eliminated based on a translation model, thus generating the translation of the input sentence. For the detailed information about the EBMT method, referring to Harold Somers, “Review Article: Example-based Machine Translation”, 1999, Machine Translation, 14(2): 113-157.

As shown in FIG. 4, the phrase fuzzy matching process of the present embodiment first at step 410, searching of phrases is performed, so as to search for identical or the most similar bilingual phrase pairs in the pre-constructed phrase table.

For example, referring to FIG. 5, in the process of searching the phrase table for the identical or the most similar bilingual phrase pair for the phrases [symbol] (This means “I found.”), [symbol] (This means “the end of her story.”) and [symbol] (This means “very exciting.”), for the phrase [symbol] (This means “I found.”), a completed matched bilingual phrase pair “(P1) [symbol] <->I found” is found; for the phrase [symbol] (This means “the end of her story.”), the most similar bilingual phrase pair “(S3) [symbol] <->the end of the story” is found; and for the phrase [symbol] (This means “very exciting.”), a completed matched bilingual phrase pair “(P4) [symbol] <->very exciting” is found.

For a long phrase such as [symbol] (This means “the end of her story.”) that has no completed matched bilingual phrase pair in the phrase table, the process of searching for the most similar bilingual phrase pair thereof is as follows: first, a plurality of similar candidate bilingual phrase pairs containing most identical words to those in the long phrase are found from the phrase table; and then, for each of the plurality of similar candidate bilingual phrase pairs, an editing distance between it and the long phrase is calculated, wherein the editing distance is the number of inserting, deleting and replacing operations required for transforming the source language phrase in the similar candidate bilingual phrase pair to the long phrase; and finally, the similar candidate bilingual phrase pairs having the shortest editing distance from the long phrase are selected as the most similar bilingual phrase pairs of the long phrase.

For example, referring to FIG. 5, for the long phrase [symbol] (This means “the end of her story.”), a plurality of similar candidate bilingual phrase pairs “(S1) [symbol] <->plot of the story”, “(S2) [symbol] <->the end of the film” and “(S3) [symbol] <->the end of the story” are found in the phrase table.

In this case, for each of the candidate bilingual phrase pairs (S1), (S2) and (S3), the editing distance between it and the long phrase [symbol] is calculated, thus obtaining: the editing distance between (S1) and the long phrase is 2, i.e., such two operations as the insertion of [symbol] (This means “her that.”) and the replacement of [symbol] (This means “plot.”) with [symbol] (This means “end.”) need to be executed in the source language phrase of (S1); the editing distance between (S2) and the long phrase is also 2, i.e., such two operations as the insertion of [symbol] (This means “her that.”) and the replacement of [symbol] (This means “film.”) with [symbol] (This means “story.”) need to be executed in the source language phrase of (S2); and the editing distance between (S3) and the long phrase is 1, i.e., only such an operation as the insertion of [symbol] needs to be executed in the source language phrase of (S3).

Thus, the bilingual phrase pair “(S3) [symbol] <->the end of the story” having the shortest editing distance from the long phrase [symbol] (This means “the end of her story.”) can be obtained as the most similar bilingual phrase pair of the long phrase.

At step 415, for each of the long phrases in the input sentence, for which no completely matched bilingual phrase pair is found but the most similar bilingual phrase pair is found, the differences between the most similar bilingual phrase pair found therefor and the long phrase are recognized. That is, different words between the source language phrase in the most similar bilingual phrase pair and the long phrase are recognized.

Specifically, at this step, one of the following methods can be used according to specific circumstances to determine whether the words in the source language phrase in the most similar bilingual phrase pair are identical to those in the long phrase:

1) The source language phrase in the most similar bilingual phrase pair and the long phrase are compared with each other on words directly to see whether the words are consistent.

2) If the long phrase is in English, the source language phrase in the most similar bilingual phrase pair and the long phrase are compared with each other on the base form of words to see whether the base form of the words are consistent.

3) By using a synonym dictionary, it is checked whether the different words between the source language phrase in the most similar bilingual phrase pair and the long phrase express a same meaning.

For example, if the most similar bilingual phrase pair found for the long phrase [symbol] (This means “the end of her story.”) in the example of FIG. 5 is “ [symbol] <->end of the novel”, then although [symbol] therein is a different word to the [symbol] (This means “story.”) in the long phrase literally, if it is defined in the synonym dictionary that [symbol] (This means “novel.”) and [symbol] (This means “story.”) belong to synonyms, then they express a same meaning, thus [symbol] (This means “novel.”) and [symbol] (This means “story.”) are not considered to be different parts herein.

4) By using a translation dictionary, it is checked whether the different words between the source language phrase in the most similar bilingual phrase pair and the long phrase express a same meaning.

Likewise, if the most similar bilingual phrase pair found for the long phrase [symbol] (This means “the end of her story.”) in the example of FIG. 5 is “ [symbol] <->end of the novel”, then if it is found in the translation dictionary that [symbol] (This means “story.”) can be translated into “story” or “novel”, and [symbol] (This means “novel.”) can be translated into “novel”, then [symbol] (This means “novel.”) and [symbol] (This means “story.”) can be considered to belong to words having a same meaning but not considered to be different parts.

At step 420, for each of the long phrases in the input sentence, for which no completely matched bilingual phrase pair is found but the most similar bilingual phrase pair is found, the differences in the most similar bilingual phrase pair to the long phrase are modified to obtain the target language translation of the long phrase.

That is, the different words in the most similar bilingual phrase pair to those of the long phrase are modified. Specifically, the words having different meanings in the source language phrase in the most similar bilingual phrase pair to those of the long phrase are modified first, so that the modified source language phrase is consistent with the long phrase, then the corresponding words in the target language phrase in the most similar bilingual phrase pair are modified, thus obtaining the target language translation of the long phrase.

For example, for the most similar bilingual phrase pair “(S3) [symbol] <->the end of the story” found for the long phrase [symbol] (This means “the end of her story.”) in the example of FIG. 5, since the difference between it and the long phrase is that the most similar bilingual phrase pair lacks the word [symbol] (This means “her.”), firstly the word [symbol] (This means “her.”) is inserted in front of the word [symbol] (This means “that.”) in the source language phrase of (S3) so that the amended source language phrase is consistent with the long phrase, then the dictionary is looked up to obtain “ [symbol] ->her”, and based on this, the corresponding word in the target language phrase of (S3) is modified according to the amended source language phrase, i.e., the second “the” in the target language phrase is replaced with “her”, thus a correct target language translation “the end of her story” of the long phrase is obtained.

Therefore, referring to FIG. 5, for the input sentence [symbol] [symbol] (This means “I found the end of her story very exciting.”), based on the following bilingual phrase pairs obtained through phrase fuzzy matching: (P1) [symbol] <->I found, (P5) [symbol] <->the end of her story and (P4) [symbol] <->very exciting, the final target language translation “I found the end of her story very exciting” having the highest score for the input sentence can be obtained by using a statistics model.

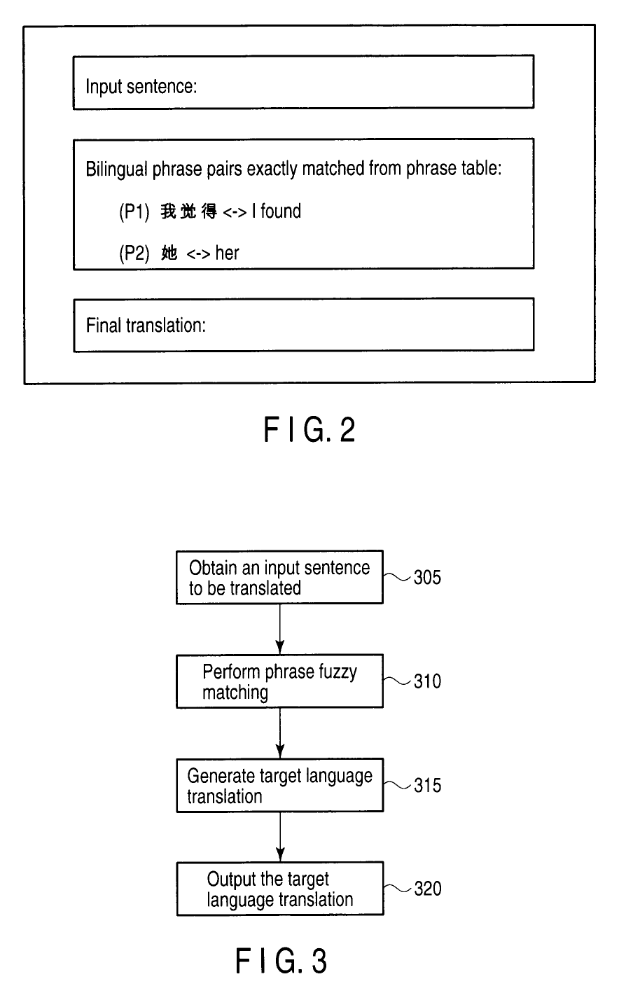

The above is a detailed description of the phrase-based statistics machine translation method of the present embodiment. In the present embodiment, by performing fuzzy matching on phrases, high quality translations can be generated for long phrases in the input sentence, thus the translating of the input sentence can be implemented based on the long phrases, which can effectively increase the quality of the translation with respect to the translation systems based on phrase exactly matching. Further, it can be seen by comparing the translation obtained based on phrase exactly matching in the example of FIG. 2 and the translation obtained based on phrase fuzzy matching according to the present embodiment in FIG. 5 that, the translation obtained based on phrase fuzzy matching is obviously better than the translation obtained based on phrase exactly matching.

In addition, it should be noted that, although in the process of FIG. 4, the example-based machine translation method is used to implement the phrase fuzzy matching process of step 310 of FIG. 3, it is not limited to this, and in other embodiments, the fuzzy matching of phrases can be implemented by using any presently known or future knowable translation concept.

Under the same inventive concept, the present invention provides a phrase-based statistics machine translation system, which will be described below in conjunction with the drawings.

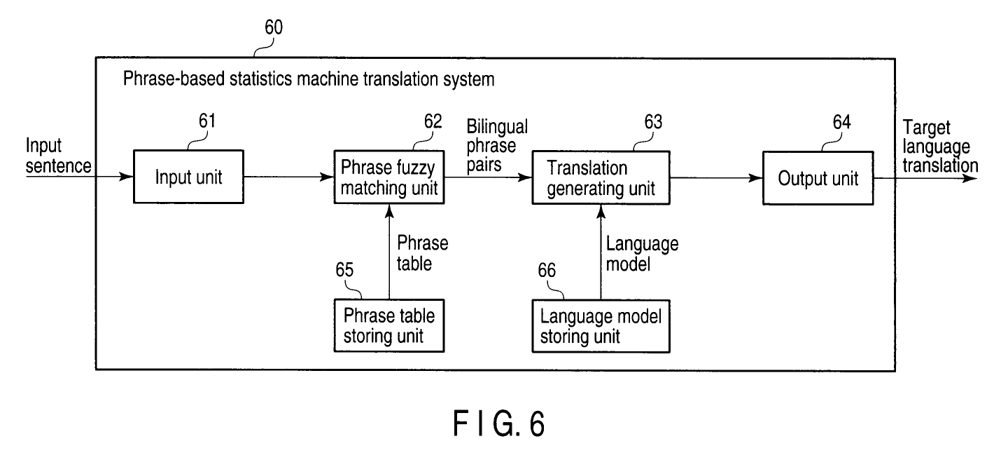

FIG. 6 is a block diagram of a phrase-based statistics machine translation system according to an embodiment of the present invention. As shown in FIG. 6, the phrase-based statistics machine translation system 60 of the present embodiment comprises input unit 61, phrase fuzzy matching unit 62, translation generating unit 63, output unit 64, phrase table storing unit 65 and language model storing unit 66.

The input unit 61 is an interface of the system 60 with the outside, and the system 60 obtains an input sentence to be translated from the outside through the input unit 61.

The phrase fuzzy matching unit 62 performs fuzzy matching for the phrases in the input sentence in a pre-constructed phrase table stored in the phrase table storing unit 65, so as to find the target language translations of the phrases.

The translation generating unit 63 finds all possible translations in a target language for the input sentence based on the matching result of the phrase fuzzy matching unit 62 and a pre-constructed language model stored in the language model storing unit 66, and selects the one having the highest score by using a statistics model as the correct target language translation of the input sentence.

Further, the target language translation generated by the translation generating unit 63 is output through the output unit 64.

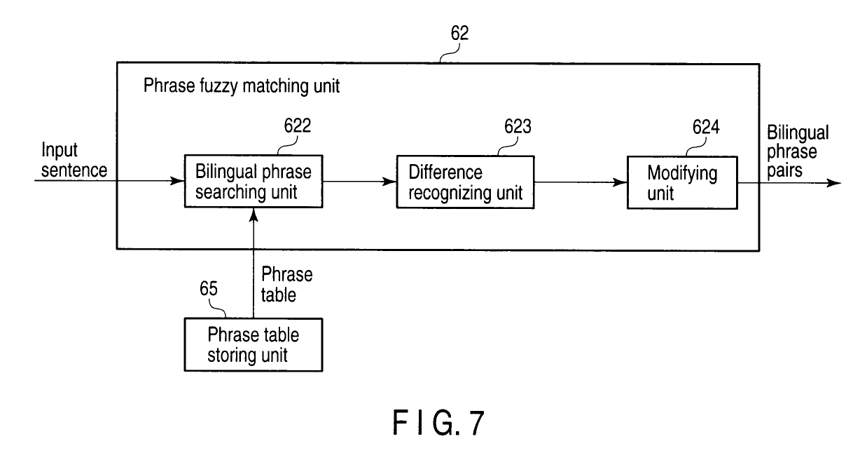

The phrase fuzzy matching unit 62 will be described in detail below. FIG. 7 is a block diagram of the phrase fuzzy matching unit according to an embodiment of the present invention. The phrase fuzzy matching unit 62 is implemented based on the example-based machine translation method.

Specifically, as shown in FIG. 7, the phrase fuzzy matching unit 62 of the present embodiment comprises bilingual phrase searching unit 622, difference recognizing unit 623 and modifying unit 624.

The bilingual phrase searching unit 622 searches the phrase table stored in the phrase table storing unit 65 for the identical or the most similar bilingual phrase pair, according to the input sentence.

Specifically, for each of long phrases for which no identical bilingual phrase pair is found, the bilingual phrase searching unit 622 finds a plurality of similar candidate bilingual phrase pairs containing most identical words to those in the long phrase from the phrase table for the long phrase; for each of the plurality of similar candidate bilingual phrase pairs, calculates an editing distance between it and the long phrase, wherein the editing distance is the number of inserting, deleting and replacing operations required for transforming the source language phrase in the similar candidate bilingual phrase pair to the long phrase; and selects the similar candidate bilingual phrase pair having the shortest editing distance from the long phrase as the most similar bilingual phrase pair of the long phrase.

The difference recognizing unit 623, for each long phrase for which the most similar bilingual phrase pair is found among the plurality of long phrases, recognizes the differences between the most similar bilingual phrase pair and the long phrase. That is, the words having different meanings between the source language phrase in the most similar bilingual phrase pair and the long phrase are recognized.

Specifically, for each long phrase for which the most similar bilingual phrase pair is found among the plurality of long phrases, the difference recognizing unit 623 recognizes the words having different meanings between the source language phrase in the most similar bilingual phrase pair and the long phrase directly or by using a synonym dictionary/translation dictionary.

The modifying unit 624, for each long phrase for which the most similar bilingual phrase pair is found among the plurality of long phrases, modifies the differences in the most similar bilingual phrase pair to the long phrase, so as to obtain the target language translation of the long phrase.

Specifically, for each long phrase for which the most similar bilingual phrase pair is found among the plurality of long phrases, the modifying unit 624 modifies the words having different meanings in the source language phrase in the most similar bilingual phrase pair to those of the long phrase, so that the modified source language phrase is consistent with the long phrase, and then modifies the corresponding words in the target language phrase in the most similar bilingual phrase pair according to the modified source language phrase.

In addition, it should be noted that, although the phrase fuzzy matching unit 62 is implemented based on the example-based machine translation method in the present embodiment, it is not limited to this, and in other embodiments, the phrase fuzzy matching unit can be implemented by using any presently known or future knowable translation concept.

The above is a detailed description of the phrase-based statistics machine translation system of the present embodiment.

The phrase-based statistics machine translation system 60 and its components can be implemented with specifically designed circuits or chips or be implemented by a computer (processor) executing corresponding programs.

While the phrase-based statistics machine translation method and system of the present invention have been described in detail with some exemplary embodiments, these embodiments are not exhaustive, and those skilled in the art may make various variations and modifications within the spirit and scope of the present invention. Therefore, the present invention is not limited to these embodiments; rather, the scope of the present invention is solely defined by the appended claims.

What is claimed is:

1. A phrase-based statistics machine translation method, comprising:
for phrases in an input sentence, performing fuzzy matching in a pre-constructed phrase table.

2. The method according to claim 1, wherein the step of for phrases in an input sentence, performing fuzzy matching in a pre-constructed phrase table further comprises:
for the phrases in the input sentence, performing fuzzy matching in the pre-constructed phrase table by using example-based machine translation method.

3. The method according to claim 1 or 2, wherein the step of for phrases in an input sentence, performing fuzzy matching in a pre-constructed phrase table further comprises:
searching the phrase table for the identical or the most similar bilingual phrase pair, according to the input sentence;
for each long phrase for which the most similar bilingual phrase pair is found among the plurality of long phrases, recognizing the differences between the most similar bilingual phrase pair and the long phrase; and
for each long phrase for which the most similar bilingual phrase pair is found among the plurality of long phrases, modifying the differences in the most similar bilingual phrase pair to the long phrase to obtain target language translation of the long phrase.

4. The method according to claim 3, wherein the step of for each of the plurality of long phrases, searching the phrase table for the identical or the most similar bilingual phrase pair further comprises, for each long phrase for which no identical bilingual phrase pair is found among the plurality of long phrases:
finding a plurality of similar candidate bilingual phrase pairs from the phrase table for the long phrase;
for each of the plurality of similar candidate bilingual phrase pairs, calculating an editing distance between it and the long phrase, wherein the editing distance is the number of inserting, deleting and replacing operations required for transforming from the source language phrase in the similar candidate bilingual phrase pair to the long phrase; and
selecting the similar candidate bilingual phrase pair having the shortest editing distance from the long phrase among the plurality of similar candidate bilingual phrase pairs as the most similar bilingual phrase pair of the long phrase.

5. The method according to claim 3, wherein the step of recognizing the differences between the most similar bilingual phrase pair and the long phrase further comprises:
recognizing the words having different meanings between the source language phrase in the most similar bilingual phrase pair and the long phrase directly or by using a synonym dictionary/translation dictionary.

6. The method according to claim 5, wherein the step of modifying the differences in the most similar bilingual phrase pair to the long phrase further comprises:
modifying the words having different meanings in the source language phrase in the most similar bilingual phrase pair to those of the long phrase, so that the modified source language phrase is consistent with the long phrase, and
modifying the corresponding words in the target language phrase in the most similar bilingual phrase pair according to the modified source language phrase.

7. The method according to claim 1, further comprising:
based on the result of the fuzzy matching for the phrases in the input sentence and a pre-constructed language model, generating target language translation having the highest score for the input sentence by using a statistics model.

8. A phrase-based statistics machine translation system, comprising:
a phrase fuzzy matching unit configured to, for phrases in an input sentence, performing fuzzy matching in a pre-constructed phrase table.

9. The system according to claim 8, wherein the phrase fuzzy matching unit is implemented according to example-based machine translation method.

10. The system according to claim 8 or 9, wherein the phrase fuzzy matching unit further comprises:
a bilingual phrase searching unit configured to search the phrase table for the identical or the most similar bilingual phrase pair;
a difference recognizing unit configured to, for each long phrase for which the most similar bilingual phrase pair is found among the plurality of long phrases, recognize the differences between the most similar bilingual phrase pair and the long phrase; and
a modifying unit configured to, for each long phrase for which the most similar bilingual phrase pair is found among the plurality of long phrases, modify the differences in the most similar bilingual phrase pair to the long phrase to obtain target language translation of the long phrase.

11. The system according to claim 10, wherein for each long phrase for which no identical bilingual phrase pair is found among the plurality of long phrases, the bilingual phrase searching unit:
finds a plurality of similar candidate bilingual phrase pairs from the phrase table for the long phrase;
for each of the plurality of similar candidate bilingual phrase pairs, calculates an editing distance between it and the long phrase, wherein the editing distance is the number of inserting, deleting and replacing operations required for transforming from the source language phrase in the similar candidate bilingual phrase pair to the long phrase; and
selects the similar candidate bilingual phrase pair having the shortest editing distance from the long phrase among the plurality of similar candidate bilingual phrase pairs as the most similar bilingual phrase pair of the long phrase.

12. The system according to claim 10, wherein for each long phrase for which the most similar bilingual phrase pair is found among the plurality of long phrases, the difference recognizing unit recognizes the words having different meanings between the source language phrase in the most similar bilingual phrase pair and the long phrase directly or by using a synonym dictionary/translation dictionary.

13. The system according to claim 12, wherein for each long phrase for which the most similar bilingual phrase pair is found among the plurality of long phrases, the modifying unit modifies the words having different meanings in the source language phrase in the most similar bilingual phrase pair to those of the long phrase, so that the modified source language phrase is consistent with the long phrase, and modifies the corresponding words in the target language phrase in the most similar bilingual phrase pair according to the modified source language phrase.

14. The system according to claim 8, further comprising:
a translation generating unit configured to, based on the result of the fuzzy matching of the phrase fuzzy matching unit and a pre-constructed language model, generate target language translation having the highest score for the input sentence by using a statistics model.
